(19) United States
(12) Patent Application Publication
(10) Pub. No.: US 2022/0056289 A1
(43) Pub. Date: Feb. 24, 2022

(54) ELECTROPHOTOGRAPHIC INK COMPOSITIONS

(71) Applicant: Hewlett-Packard Development Company, L.P., Spring, TX (US)

(72) Inventors: Hanit Marom Tchaicheeyan, Ness Ziona (IL); Albert Teishev, Ness Ziona (IL); Adi Mann, Ness Ziona (IL); Orel Yosef Mizrahi, Ness Ziona (IL); Doron Gurovich, Ness Ziona (IL); Vladislav Kaploun, Ness Ziona (IL)

(73) Assignee: Hewlett-Packard Development Company, L.P., Spring, TX (US)

(21) Appl. No.: 17/417,792

(22) PCT Filed: Feb. 4, 2019
(86) PCT No.: PCT/US2019/016482

§ 371 Date: Jun. 24, 2021

(51) Int. Cl. C09D 11/107; C09D 11/52

(52) U.S. Cl. CPC C09D 11/107; C09D 11/52

(57) ABSTRACT

Disclosed herein is a liquid electrophotographic ink composition comprising a resin comprising a copolymer of an alkylene monomer and a monomer selected from acrylic acid and methacrylic acid; a liquid carrier; and an anti-caking agent present in an amount of up to 1 wt. % of the total solids of the composition. Also disclosed is a method of printing the liquid electrophotographic ink composition and a printed substrate.

Electrostatic printing processes can involve creating an image on a photoconductive surface, applying an ink having charged particles to the photoconductive surface, such that they selectively bind to the image, and then transferring the charged particles in the form of the image to a print substrate.

The photoconductive surface may be on a cylinder and may be termed a photo imaging plate (PIP). The photoconductive surface is selectively charged with a latent electrostatic image having image and background areas with different potentials. For example, an electrostatic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper or plastic film) directly or, more commonly, by being first transferred to an intermediate transfer member, which can be a soft swelling blanket, and then to the print substrate.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “carrier,” “liquid carrier”, or “carrier vehicle” refers to the fluid in which pigment particles, resin, charge directors and other additives can be dispersed to form a liquid electrostatic ink composition or liquid electrophotographic ink composition. The carrier liquids may include a mixture of a variety of different agents, such as surfactants, co-solvents, viscosity modifiers, and/or other possible ingredients.

As used herein, “liquid electrostatic ink composition” or “liquid electrophotographic composition” generally refers to an ink composition that is typically suitable for use in an electrostatic printing process, sometimes termed an electrophotographic printing process. It may comprise pigment particles having a thermoplastic resin thereon. The electrostatic ink composition may be a liquid electrostatic ink composition, in which the pigment particles having resin thereon are suspended in a carrier liquid. The pigment particles having resin thereon will typically be charged or capable of developing charge in an electric field, such that they display electrophoretic behaviour. A charge director may be present to impart a charge to the pigment particles having resin thereon.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, unless otherwise stated, “melt flow rate” is measured per ASTM D1238 Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the liquid electrostatic ink composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa·s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate, such as a plastic film. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrostatic printing” is a specific type of electrostatic printing in which a liquid composition is employed in the electrophotographic process rather than a powder toner. An electrostatic printing process may involve subjecting the electrostatic composition to an electric field, for example, an electric field having a field gradient of 50-400 V/μm, or more, in some examples, 600-900V/μm, or more.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a liquid electrophotographic ink composition. The liquid electrophotographic ink composition may comprise:
a resin comprising a copolymer of an alkylene monomer and a monomer selected from acrylic acid and methacrylic acid;
a liquid carrier; and
an anti-caking agent present in an amount of up to 1 wt. % of the total solids of the composition.

In another aspect, there is provided a method of liquid electrophotographic printing.

The liquid electrophotographic ink composition may comprise:
diluting a liquid electrophotographic ink composition with a liquid carrier to form a print ready composition, the liquid electrophotographic ink composition comprising:
   a resin comprising a copolymer of an alkylene monomer and a monomer selected from acrylic acid and methacrylic acid;
   a liquid carrier; and
   an anti-caking agent present in an amount of up to 1 wt. % of the total solids of the composition; and
electrophotographically printing the print ready composition onto a substrate.

In a further aspect, there is provided a printed substrate. The printed substrate may comprise:
a substrate; and
a printed ink composition disposed on the substrate;
wherein the printed ink composition comprises:
   a resin comprising a copolymer of an alkylene monomer and a monomer selected from acrylic acid and methacrylic acid; and
   an anti-caking agent present in an amount of up to 1 wt. % of the total solids of the composition.

Many liquid electrophotographic ink compositions are sold in concentrated form and diluted by using an in-line dispersion unit forming part of the liquid electrophotographic ink compositions. This reduces transportation costs, ink cartridge replacement frequency and carrier liquid waste. However, current liquid electrophotographic ink compositions can only be re-dispersed using an in-line dispersion unit from a concentration of 60 wt. % solids. Particle agglomeration occurs if the liquid electrophotographic ink compositions are concentrated to higher weight percentage solids, causing caking and flow issues. Caking and flow problems of concentrated ink compositions cause blockages in machinery, imprecise dosages during printing and printer downtime. Additionally, even after re-dispersion of the compositions, the particle sizes are higher than for ink compositions that have only been concentrated to 60 wt. % solids or less. The addition of only 0.5 wt. % silica as an anti-caking agent has been found to enable concentration of the electrophotographic ink composition to 75 wt. % solids without detrimentally affecting the re-dispersion of the ink composition and the printing of that re-dispersed composition. Without wishing to be bound by any particular theory, it is believed that the anti-caking agent may form a shell around the particles in the liquid electrophotographic ink composition, preventing agglomeration of the particles. It is also believed that the anti-caking agent may prevent or reduce settling of the particles by increasing the viscosity, creating a flow limit.

### Electrophotographic Ink Composition

In an aspect, there is provided an electrophotographic ink composition. The electrophotographic ink composition may comprise a resin comprising a copolymer of an alkylene monomer and a monomer selected from acrylic acid and methacrylic acid;

a liquid carrier; and an anti-caking agent present in an amount of up to 1 wt. % of the total solids of the composition.

In some examples, the liquid electrophotographic ink composition may further comprise a colorant.

In some examples, the liquid electrophotographic ink composition may further comprise a charge adjuvant. In some examples, the liquid electrophotographic ink composition may further comprise a charge adjuvant and a colorant.

In some examples, the liquid electrophotographic ink composition may further comprise a charge director. In some examples, liquid electrophotographic ink composition may further comprise a charge director and a colorant. In some examples, the liquid electrophotographic ink composition may further comprise a charge director and a charge adjuvant. In some examples, the liquid electrophotographic ink composition may further comprise a charge director, a charge adjuvant and a colorant.

In some examples, the liquid electrophotographic ink composition comprises particles dispersed in a carrier liquid, wherein the particles comprise a resin and an anti-caking agent. In some examples, the liquid electrophotographic ink composition comprises particles dispersed in a carrier liquid, wherein the particles comprise a resin, an anti-caking agent and a colorant. In some examples, the anti-caking agent may form a shell around the particles. In some examples, the anti-caking agent may form a shell around the particles, preventing agglomeration of the particles.

In some examples, the liquid electrophotographic ink composition may further comprise other additives or a plurality of other additives.

In some examples, the non-volatile solids content of the electrophotographic ink composition may be 65 wt. % or more, for example, 66 wt. % or more, 67 wt. % or more, 68 wt. % or more, 69 wt. % or more, 70 wt. % or more, 71 wt. % or more, 72 wt. % or more, 73 wt. % or more, 74 wt. % or more, 75 wt. % or more, 76 wt. % or more, 77 wt. % or more, 78 wt. % or more, 79 wt. % or more, or 80 wt. % or more. In some examples, the non-volatile solids content of the electrophotographic ink composition may be 80 wt. % or less, for example, 79 wt. % or less, 78 wt. % or less, 77 wt. % or less, 76 wt. % or less, 75 wt. % or less, 74 wt. % or less, 73 wt. % or less, 72 wt. % or less, 71 wt. % or less, 70 wt. % or less, 69 wt. % or less, 68 wt. % or less, 67 wt. % or less, 66 wt. % or less, or 65 wt. % or less. In some examples, the non-volatile solids content of the electrophotographic ink composition may be 65 wt. % to 80 wt. %, 66 wt. % to 80 wt. %, 67 wt. % to 80 wt. %, 68 wt. % to 79 wt. %, 69 wt. % to 79 wt. %, 70 wt. % to 78 wt. %, 71 wt. % to 78 wt. %, 72 wt. % to 78 wt. %, 73 wt. % to 77 wt. %, 74 wt. % to 77 wt. %, or 75 wt. % to 76 wt. %. In some examples, the remaining weight percentage is made up of liquid carrier.

### Anti-Caking Agent

In some examples, the electrophotographic ink composition comprises an anti-caking agent present in an amount of up to 1 wt. % of the total solids of the composition. In some examples, the anti-caking agent may be present in an amount of up to 0.95 wt. % of the total solids of the composition, for example, to 0.95 wt. % of the total solids of the composition, for example, up to 0.9 wt. %, up to 0.85 wt. %, up to 0.8 wt. %, up to 0.75 wt. %, up to 0.7 wt. %, up to 0.65 wt. %, up to 0.6 wt. %, up to 0.55 wt. %, up to 0.5 wt. %, up to 0.45 wt. %, up to 0.4 wt. %, up to 0.35 wt. %, up to 0.3 wt. %, up to 0.25 wt. %, up to 0.2 wt. %, up to 0.15 wt. % or up to 0.1 wt. %. In some examples, the anti-caking agent may be present in an amount of about 0.1 wt. % to about 0.9 wt. %, about 0.15 wt. % to about 0.85 wt. %, about 0.2 wt. % to about 0.8 wt. %, about 0.25 wt. % to about 0.75 wt. %, about 0.3 wt. % to about 0.7 wt. %, about 0.35 wt. % to about 0.65 wt. %, about 0.4 wt. % to about 0.6 wt. %, about 0.45 wt. % to about 0.55 wt. %, or about 0.5 wt. % to about 0.55 wt. %.

In some examples, the anti-caking agent is any agent capable of preventing agglomeration of the particles of the liquid electrophotographic ink composition at solids contents of 65 wt. % or more. In some examples, the anti-caking agent is any agent capable of preventing agglomeration of the particles of the liquid electrophotographic ink composition at solids contents of 65 wt. % to 80 wt. %, for example, 70 wt. % to 75 wt. %.

In some examples, the anti-caking agent is selected from silica, tricalcium phosphate, powdered cellulose, magnesium stearate, sodium bicarbonate, sodium ferrocyanide, potassium ferrocyanide, calcium ferrocyanide, sodium silicate, calcium silicate, magnesium trisilicate, sodium aluminosilicate, potassium aluminium silicate, calcium aluminosilicate, aluminium silicate, stearic acid, polydimethylsiloxane, and combinations thereof. In some examples, the anti-caking agent is selected from silica, tricalcium phosphate, powdered cellulose, magnesium stearate, sodium bicarbonate, sodium ferrocyanide, potassium ferrocyanide, calcium ferrocyanide, sodium silicate, calcium silicate, magnesium trisilicate, sodium aluminosilicate, potassium aluminium silicate, calcium aluminosilicate, aluminium silicate, stearic acid, and polydimethylsiloxane.

In some examples, the anti-caking agent is silica. In some examples, the silica is fumed silica. Fumed silica is also known as pyrogenic silica. In some examples, the fumed silica is hydrophobic fumed silica. In some examples, the fumed silica has been treated with a surface treatment agent, for example, with dimethyldichlorosilane, hexadecylsilane, hexamethyldisilazane. diethyldichlorosilane, allylmethyldichlorosilane, trimethylbutoxysilane, trivinyltrimethylcyclotrisiloxane, octamethylcyclotetra-siloxane, hexaethyldisiloxane, pentylmethyldichlorosilane, trimethylchlorosilane, hexamethyldisiloxane, hexenylmethyldichlorosilane, hexenyldimethylchlorosilane, dimethylchlorosilane, dimethyldichlorosilane and so forth. In some examples, the fumed silica has been treated with a surface treatment agent selected from dimethyldichlorosilane, hexadecylsilane and hexamethyldisilazane.

In some examples, the anti-caking agent may have a median particle size of 50 nm or less, 45 nm or less, 40 nm or less, 35 nm or less, 30 nm or less, 25 nm or less, 20 nm or less, 15 nm or less, 10 nm or less, 5 nm or less, 4 nm or less, 3 nm or less, 2 nm or less, 1 nm or less. In some examples, the anti-caking agent may have a median particle size of 1 nm or more, for example, 2 nm or more, 3 nm or more, 4 nm or more, 5 nm or more, 10 nm or more, 15 nm or more, 20 nm or more, 25 nm or more, 30 nm or more, 35 nm or more, 40 nm or more, 45 nm or more or 50 nm or more. In some examples, the anti-caking agent may have a median particle size of about 1 nm to about 50 nm, about 2 nm to about 45 nm, about 3 nm to about 40 nm, about 4 nm to about 35 nm, about 5 nm to about 30 nm, about 10 nm to about 25 nm, about 15 nm to about 50 nm, about 20 nm to about 45 nm, or about 25 nm to about 40 nm. The median particle size of the anti-caking agent is the volume-based median particle size and may be measured using a Malvern Mastersizer 2000 Particle Size Analyzer.

In some examples, the anti-caking agent may have a density of 1 g/cm³ or more, for example, 1.1 g/cm³ or more, 1.2 g/cm³ or more, 1.3 g/cm³ or more, 1.4 g/cm³ or more, 1.5 g/cm³ or more, 1.6 g/cm³ or more, 1.7 g/cm³ or more, 1.8 g/cm³ or more, 1.9 g/cm³ or more, 2 g/cm³ or more, 2.1 g/cm³ or more, 2.2 g/cm³ or more, 2.3 g/cm³ or more, 2.4 g/cm³ or more, 2.5 g/cm³ or more, 2.6 g/cm³ or more, 2.7 g/cm³ or more, 2.8 g/cm³ or more, 2.9 g/cm³ or more, 3 g/cm³ or more, 3.5 g/cm³ or more, 4 g/cm³ or more, 4.5 g/cm³ or more, or 5 g/cm³ or more. In some examples, the anti-caking agent may have a density of 5 g/cm³ or less, for example, 4.5 g/cm³ or less, 4 g/cm³ or less, 3.5 g/cm³ or less, 3.4 g/cm³ or less, 3.3 g/cm³ or less, 3.2 g/cm³ or less, 3.1 g/cm³ or less, 3 g/cm³ or less, 2.9 g/cm³ or less, 2.8 g/cm³ or less, 2.7 g/cm³ or less, 2.6 g/cm³ or less, 2.5 g/cm³ or less, 2.4 g/cm³ or less, 2.3 g/cm³ or less, 2.2 g/cm³ or less, 2.1 g/cm³ or less, 2 g/cm³ or less, 1.9 g/cm³ or less, 1.8 g/cm³ or less, 1.7 g/cm³ or less, 1.6 g/cm³ or less, 1.5 g/cm³ or less, 1.4 g/cm³ or less, 1.3 g/cm³ or less, 1.2 g/cm³ or less, or 1.1 g/cm³ or less. In some examples, the anti-caking agent may have a density of 1 g/cm³ to 5 g/cm³, for example, 1.1 g/cm³ to 4.5 g/cm³, 1.2 g/cm³ to 4 g/cm³, 1.3 g/cm³ to 3.5 g/cm³, 1.4 g/cm³ to 3.4 g/cm³, 1.5 g/cm³ to 3.3 g/cm³, 1.6 g/cm³ to 3.2 g/cm³, 1.7 g/cm³ to 3.1 g/cm³, 1.8 g/cm³ to 3 g/cm³, 1.9 g/cm³ to 2.9 g/cm³, 2 g/cm³ to 2.8 g/cm³, 2.1 g/cm³ to 2.7 g/cm³, 2.2 g/cm³ to 2.6 g/cm³, 2.3 g/cm³ to 2.5 g/cm³, or 2.4 g/cm³ to 2.5 g/cm³.

In some examples, the anti-caking agent is fumed silica and has a carbon content of 5 wt. % or less, for example, 4.5 wt. % or less, 4 wt. % or less, 3.5 wt. % or less, 3 wt. % or less, 2.5 wt. % or less, 2 wt. % or less, 1.5 wt. % or less, 1 wt. % or less, or 0.5 wt. % or less. In some examples, the anti-caking agent is fumed silica and has a carbon content of 0.5 wt. % or more, for example, 1 wt. % or more, 1.5 wt. % or more, 2 wt. % or more, 2.5 wt. % or more, 3 wt. % or more, 3.5 wt. % or more, 4 wt. % or more, 4.5 wt. % or more, or 5 wt. % or more. In some examples, the anti-caking agent is fumed silica and has a carbon content of 0.5 wt. % to 5 wt. %, for example, 1 wt. % to 4.5 wt. %, 1.5 wt. % to 4 wt. %, 2 wt. % to 3.5 wt. %, or 2.5 wt. % to 3 wt. %.

### Resin

In some examples, the liquid electrophotographic ink composition comprise a resin. In some examples, the resin comprises a copolymer of an alkylene monomer and a monomer selected from acrylic acid and methacrylic acid. In some examples, the liquid electrophotographic ink composition may comprise a copolymer of an alkylene monomer and an acrylic acid monomer and a copolymer of an alkylene monomer and a methacrylic acid monomer. In some examples, the alkylene monomer may be selected from ethylene and propylene.

In some examples, the liquid electrophotographic ink composition comprises a resin comprising a copolymer of an alkylene monomer and a monomer selected from acrylic acid and methacrylic acid. The resin may be referred to as a thermoplastic polymer. A thermoplastic polymer is sometimes referred to as a thermoplastic resin. In some examples, the polymer may comprise one or more of ethylene or propylene acrylic acid co-polymers; ethylene or propylene methacrylic acid co-polymers; ethylene vinyl acetate co-polymers; co-polymers of ethylene or propylene (e.g. 80 wt. % to 99.9 wt. %), and alkyl (e.g. C1 to C5) ester of methacrylic or acrylic acid (e.g. 0.1 wt. % to 20 wt. %); co-polymers of ethylene (e.g. 80 wt. % to 99.9 wt. %), acrylic or methacrylic acid (e.g. 0.1 wt. % to 20.0 wt. %) and alkyl (e.g. C1 to C5) ester of methacrylic or acrylic acid (e.g. 0.1 wt. % to 20 wt. %); co-polymers of ethylene or propylene (e.g. 70 wt. % to 99.9 wt. %) and maleic anhydride (e.g. 0.1 wt. % to 30 wt. %); polyethylene; polystyrene; isotactic polypropylene (crystalline); co-polymers of ethylene ethylene ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt. % to 20 wt. %)/ethylhexylacrylate (e.g. 10 wt. % to 50 wt. %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin comprises a polymer having acidic side groups. Examples of the polymer having acidic side groups will now be described. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN® ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitutes from 5 wt. % to about 25 wt. % of the co-polymer, in some examples from 10 wt. % to about 20 wt. % of the co-polymer.

The resin may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 or AC-5180 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of polymer, the polymer (excluding any other components of the electrophotographic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrophotographic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000

Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g. Zn, Na, Li) such as SURLYN® ionomers. The resin may comprise (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt. % to about 16 wt. % of the co-polymer, in some examples 10 wt. % to 16 wt. % of the co-polymer; and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt. % to about 30 wt. % of the co-polymer, in some examples from 14 wt. % to about 20 wt. % of the co-polymer, in some examples from 16 wt. % to about 20 wt. % of the co-polymer in some examples from 17 wt. % to 19 wt. % of the co-polymer.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. In some examples, the first monomer can constitute 5% to 40% by weight of the co-polymer, and the second monomer constitutes 5% to 40% by weight of the co-polymer, with the third monomer constituting the remaining weight of the co-polymer. In some examples, the first monomer constitutes 5% to 15% by weight of the co-polymer and the second monomer constitutes 5% to 15% by weight of the co-polymer, with the third monomer constituting the remaining weight of the co-polymer. In some examples, the first monomer constitutes 8% to 12% by weight of the co-polymer and the second monomer constitutes 8% to 12% by weight of the co-polymer, with the third monomer constituting the remaining weight of the co-polymer. In some examples, the first monomer constitutes about 10% by weight of the co-polymer and the second monomer constitutes about 10% by weight of the co-polymer, with the third monomer constituting the remaining weight of the co-polymer. The polymer may be selected from the Bynel® class of monomer, including Bynel 2022 and Bynel 2002, which are available from DuPont®.

The polymer having ester side groups may constitute 1% or more by weight of the total amount of the resin polymers, e.g. thermoplastic resin polymers, in the liquid electrophotographic ink composition and/or the ink printed on the print substrate, e.g. the total amount of the polymer or polymers having acidic side groups and polymer having ester side groups. The polymer having ester side groups may constitute 5% or more by weight of the total amount of the resin polymers, e.g. thermoplastic resin polymers, in some examples 8% or more by weight of the total amount of the resin polymers, e.g. thermoplastic resin polymers, in some examples 10% or more by weight of the total amount of the resin polymers, e.g. thermoplastic resin polymers, in some examples 15% or more by weight of the total amount of the resin polymers, e.g. thermoplastic resin polymers, in some examples 20% or more by weight of the total amount of the resin polymers, e.g. thermoplastic resin polymers, in some examples 25% or more by weight of the total amount of the resin polymers, e.g. thermoplastic resin polymers, in some examples 30% or more by weight of the total amount of the resin polymers, e.g. thermoplastic resin polymers, in some examples 35% or more by weight of the total amount of the resin polymers, e.g. thermoplastic resin polymers, in the liquid electrophotographic composition and/or the ink printed on the print substrate. The polymer having ester side groups may constitute from 5% to 50% by weight of the total amount of the resin polymers, e.g. thermoplastic resin polymers, in the liquid electrophotographic composition and/or the ink printed on the print substrate, in some examples 10% to 40% by weight of the total amount of the resin polymers, e.g. thermoplastic resin polymers, in the liquid electrophotographic composition and/or the ink composition printed on the print substrate, in some examples 5% to 30% by weight of the total amount of the resin polymers, e.g. thermoplastic resin polymers, in the liquid electrophotographic composition and/or the ink composition printed on the print substrate, in some examples 5% to 15% by weight of the total amount of the resin polymers, e.g. thermoplastic resin polymers, in the liquid electrophotographic composition and/or the ink composition printed on the print substrate in some examples 15% to 30% by weight of the total amount of the resin polymers, e.g. thermoplastic resin polymers, in the liquid electrophotographic composition and/or the ink composition printed on the print substrate.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the Nucrel family of toners (e.g. Nucrel 403™, Nucrel407™, Nucrel 609HS™, Nucrel 908HS™, Nucrel 1202HC™, Nucrel30707™, Nucrel1214™, Nucrel 903™, Nucrel3990™, Nucrel910™, Nucrel925™, Nucrel699™, Nucrel 599™, Nucrel 960™, Nucrel RX76™, Nucrel2806™, Bynell 2002, Bynell 2014, Bynell 2020 and Bynell 2022, (sold by E. I. du PONT)), the AC family of toners (e.g. AC-5120, AC-5180, AC-540, AC-580 (sold by Honeywell)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

The resin can constitute about 5 to 90%, in some examples about 50 to 80%, by weight of the solids of the liquid electrophotographic ink composition and/or the ink composition printed on the substrate. The resin can constitute about 60 to 95%, in some examples about 70 to 95%, by weight of the solids of the liquid electrophotographic ink composition and/or the ink composition printed on the substrate.

### Liquid Carrier

In some examples, the electrostatic ink composition comprises a carrier liquid.

The carrier liquid can include or be a hydrocarbon, silicone oil, vegetable oil, etc. The carrier liquid can include, for example, an insulating, non-polar, non-aqueous liquid that can be used as a medium for ink particles, i.e., the ink particles comprising the resin and, in some examples, a colorant. The carrier liquid can include compounds that have a resistivity in excess of about 10⁹ ohm·cm. The carrier liquid may have a dielectric constant below about 5, in some examples, below about 3. The carrier liquid can include hydrocarbons. The hydrocarbon can include, for example, an aliphatic hydrocarbon, an isomerized aliphatic hydrocarbon, branched chain aliphatic hydrocarbons, aromatic hydrocarbons, and combinations thereof. Examples of the carrier liquid include, for example, aliphatic hydrocarbons, isoparaffinic compounds, paraffinic compounds, dearomatized hydrocarbon compounds, and the like. In particular, the carrier liquid can include, for example, Isopar-G™, Isopar-H™, Isopar-L™, Isopar-M™, Isopar-K™, Isopar-V™, Norpar12™, Norpar13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol300™, Nisseki Isosol400®, AF-4™, AF-5™, AF-6™ and AF-7™ (each sold by NIPPON OIL CORPORATION); IP Solvent 1620™ and IP Solvent2028™ (each sold by IDEMITSU PETROCHEMICAL CO., LTD.); Amsco OMS™ and Amsco460™ (each sold by AMERICAN MINERAL SPIRITS CORP.); and Electron, Positron, New II, Purogen HF (100% synthetic terpenes) (sold by ECOLINK™).

The carrier liquid can constitute up to 35 wt. % of the liquid electrophotographic ink composition, for example, up to 34 wt. %, up to 33 wt. %, up to 32 wt. %, up to 31 wt. %, up to 30 wt. %, up to 29 wt. %, up to 28 wt. %, up to 27 wt. %, up to 26 wt. %, up to 25 wt. %, up to 24 wt. %, up to 23 wt. %, up to 22 wt. %, up to 21 wt. %, or up to 20 wt. % of the liquid electrophotographic ink composition. In some examples, the carrier liquid can constitutes 20 wt. % or more of the liquid electrophotographic ink composition, for example, 21 wt. % or more, 22 wt. % or more, 23 wt. % or more, 24 wt. % or more, 25 wt. % or more, 26 wt. % or more, 27 wt. % or more, 28 wt. % or more, 29 wt. % or more, 30 wt. % or more, 31 wt. % or more, 32 wt. % or more, 33 wt. % or more, 34 wt. % or more, or 35 wt. % or more of the liquid electrophotographic ink composition. In some examples, the carrier liquid can constitute 20 wt. % to 35 wt. % of the liquid electrophotographic ink composition, for example, 21 wt. % to 35 wt. %, 22 wt. % to 34 wt. %, 23 wt. % to 33 wt. %, 24 wt. % to 32 wt. %, 25 wt. % to 31 wt. %, 26 wt. % to 30 wt. %, 27 wt. % to 29 wt. %, or 28 wt. % to 35 wt. %.

In some examples, after diluting the liquid electrophotographic ink composition with liquid carrier, the carrier liquid can constitute about 20% to 99.5% by weight of the electrophotographic ink composition, in some examples, 50% to 99.5% by weight of the electrophotographic ink composition. In some examples, after diluting the liquid electrophotographic ink composition with liquid carrier, the carrier liquid may constitute about 40 to 90% by weight of the electrophotographic ink composition. In some examples, after diluting the liquid electrophotographic ink composition with liquid carrier, the carrier liquid may constitute about 60% to 80% by weight of the electrophotographic ink composition. In some examples, after diluting the liquid electrophotographic ink composition with liquid carrier, the carrier liquid may constitute about 90% to 99.5% by weight of the electrophotographic ink composition, in some examples, 95% to 99% by weight of the electrophotographic ink composition.

The electrophotographic ink composition, when printed on a substrate may be substantially free from carrier liquid. In an electrophotographic printing process and/or afterwards, the carrier liquid may be removed, for example, by an electrophoresis processes during printing and/or evaporation, such that substantially just solids are transferred to the substrate. Substantially free from carrier liquid may indicate that the ink printed on the substrate contains less than 5 wt. % carrier liquid, in some examples, less than 2 wt. % carrier liquid, in some examples, less than 1 wt. % carrier liquid, in some examples, less than 0.5 wt. % carrier liquid. In some examples, the ink printed on the substrate is free from carrier liquid.

### Colorant

The electrostatic ink composition may include a colorant. In some examples, the colorant may be a dye or pigment.

In some examples, the electrostatic ink composition may be a white electrostatic ink composition. In some examples, the electrostatic ink composition comprises a white pigment.

The electrostatic ink composition may substantially lack or lack a colorant. The electrostatic ink composition may be a transparent electrostatic ink composition. In some examples, the transparent electrostatic ink composition does not contain any colorant, or substantially lacks colorant and thus is a colorant-free composition or substantially colorant-free composition. The transparent electrostatic ink composition may otherwise be termed a colourless electrostatic ink composition or a colourless varnish for electrostatic printing. In some examples, substantially lacks may indicate that the transparent electrostatic ink composition comprises 5 wt. % solids or less of colorant, in some examples, 3 wt. % solids or less of colorant, in some examples, 1 wt. % solids or less of colorant. “Colorant” may be a material that imparts a colour to the ink composition. As used herein, “colorant” includes pigments and dyes, such as those that impart colours, such as black, magenta, cyan, yellow and white to an ink. As used herein, “pigment” generally includes pigment colorants, magnetic particles, aluminas, silicas, and/or other ceramics or organometallics. Thus, though the present description primarily exemplifies the use of pigment colorants, the term “pigment” can be used more generally to describe not only pigment colorants, but also other pigments such as organometallics, ferrites, ceramics, and so forth.

The colorant can be any colorant compatible with the carrier liquid and useful for electrostatic printing. For example, the colorant may be present as pigment particles, or may comprise a resin as described herein and a pigment. The pigments can be any of those standardly used in the art. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW SGT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. If the pigment is a white pigment, the pigment particle may be selected from the group consisting of TiO₂, calcium carbonate, zinc oxide, and mixtures thereof. In some examples, the white pigment particle may comprise an alumina-TiO₂ pigment.

The colorant or pigment may be present in the electrostatic ink composition in an amount of from 10 wt. % to 80 wt. % of the total amount of resin and colorant, in some examples, 15 wt. % to 80 wt. %, in some examples 15 wt. % to 60 wt. %, in some examples, 15 wt. % to 50 wt. %, in some examples, 15 wt. % to 40 wt. %, in some examples, 15 wt. % to 30 wt. % of the total amount of resin and colorant. In some examples, the colorant or pigment particle may be present in the electrostatic ink in an amount of at least 50 wt. % of the total amount of resin and colorant or pigment, for example at least 55 wt. % of the total amount of resin and colorant or pigment.

### Charge Adjuvant

In some examples, the liquid electrostatic ink composition includes a charge adjuvant. A charge adjuvant may promote charging of the particles when a charge director is present. The method of producing an electrostatic ink composition, as described herein, may involve adding a charge adjuvant at any stage. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminum di- or tristearate. In some examples, the charge adjuvant is VCA (an aluminium stearate, available from Sigma Aldrich).

In some examples, the electrostatic ink composition further includes a salt of a multivalent cation and a fatty acid anion. The salt of a multivalent cation and a fatty acid anion can act as a charge adjuvant. The multivalent cation may, in some examples, be a divalent or a trivalent cation. In some examples, the multivalent cation is selected from Group 2, transition metals, Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be a C₈ to C₂₆ fatty acid anion, in some examples, a C₁₄ to C₂₂ fatty acid anion, in some examples, a C₁₆ to C₂₀ fatty acid anion, in some examples, a C₁₇, C₁₈ or C₁₉ fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant may be present in an amount of about 0.1% to about 5% by weight, in some examples, about 0.1% to about 1% by weight, in some examples, about 0.3% to about 0.8% by weight of the solids of the electrostatic ink composition, in some examples, about 1 wt. % to about 3 wt. % of the solids of the electrostatic ink composition, in some examples, about 1.5 wt. % to about 2.5 wt. % of the solids of the electrostatic ink composition.

The charge adjuvant may be present in an amount of about 5.0% by weight or less of total solids of the electrostatic ink composition, in some examples, in an amount of about 4.5% by weight or less, in some examples, in an amount of about 4.0% by weight or less, in some examples, in an amount of about 3.5% by weight or less, in some examples, in an amount of about 3.0% by weight or less, in some examples, in an amount of about 2.5% by weight or less, in some examples, about 2.0% or less by weight of the solids of the electrostatic ink composition.

The charge adjuvant, which may, for example, be or include a salt of a multivalent cation and a fatty acid anion, may be present in an amount of about 0.1 wt. % to about 5 wt. % of the solids of the electrostatic ink composition, in some examples, in an amount of about 0.1 wt. % to about 2 wt. % of the solids of the electrostatic ink composition, in some examples, in an amount of about 0.3 wt. % to about 1.5 wt. % of the solids of the electrostatic ink composition, in some examples, about 0.5 wt. % to about 1.2 wt. % of the solids of the electrostatic ink composition, in some examples, about 0.8 wt. % to about 1 wt. % of the solids of the electrostatic ink composition, in some examples, about 1 wt. % to about 3 wt. % of the solids of the electrostatic ink composition, in some examples, about 1.5 wt. % to about 2.5 wt. % of the solids of the electrostatic ink composition.

### Charge Director

In some examples, the liquid electrostatic ink composition includes a charge director. The charge director may be added to a liquid electrostatic ink composition in order to impart and/or maintain sufficient electrostatic charge on the resin particles. In some examples, the charge director may comprise ionic compounds, particularly metal salts of fatty acids, metal salts of sulfosuccinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g., neutral Calcium Petronate™, neutral Barium Petronate™ and basic Barium Petronate™), polybutylene succinimides (e.g. OLOA™ 1200 and Amoco 575), and glyceride salts (e.g., sodium salts of phosphated mono- and diglycerides with unsaturated and saturated acid substituents), sulfonic acid salts including, but not limited to, barium, sodium, calcium, and aluminium salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of a liquid electrostatic ink composition.

The charge director may be added in order to impart and/or maintain sufficient electrostatic charge on the ink particles, which may be particles comprising the first resin and the second resin.

In some examples, the electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cr, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof.

In some examples, the electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃)—C(O)—O—R²], wherein each of R¹ and R² is an alkyl group. In some examples each of R¹ and R² is an aliphatic alkyl group. In some examples, each of R¹ and R² independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same. In some examples, at least one of R¹ and R² is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples, 2 nm or more.

The charge director may include one of, some of or all of (i) soya lecithin, (ii) a barium sulfonate salt, such as basic barium petronate (BPP), and (iii) an isopropyl amine sulfonate salt. Basic barium petronate is a barium sulfonate salt of a C21-26 hydrocarbon alkyl, and can be obtained, for example, from Chemtura. An example isopropyl amine sulfonate salt is dodecyl benzene sulfonic acid isopropyl amine, which is available from Croda.

In some examples, the charge director constitutes about 0.001% to about 20%, in some examples, about 0.01% to about 20% by weight, in some examples, about 0.01 to about 10% by weight, in some examples, about 0.01% to about 1% by weight of the solids of an electrostatic ink composition. In some examples, the charge director constitutes about 0.001% to about 0.15% by weight of the solids of the electrostatic ink composition, in some examples, about 0.001% to about 0.15%, in some examples, about 0.001% to about 0.02% by weight of the solids of an electrostatic ink composition, in some examples, about 0.1% to about 2% by weight of the solids of the electrostatic ink composition, in some examples, about 0.2% to about 1.5% by weight of the solids of the electrostatic ink composition, in some examples, about 0.1% to about 1% by weight of the solids of the electrostatic ink composition, in some examples, about 0.2% to about 0.8% by weight of the solids of the electrostatic ink composition.

In some examples, the charge director is present in an amount of from about 3 mg/g to about 80 mg/g, in some examples, 3 mg/g to about 50 mg/g, in some examples, 3 mg/g to about 20 mg/g, in some examples, from about 3 mg/g to about 15 mg/g, in some examples, from about 10 mg/g to about 15 mg/g, in some examples, from about 5 mg/g to about 10 mg/g (where mg/g indicates mg per gram of solids of the electrostatic ink composition).

### Other Additives

The electrostatic ink composition may include other additives or a plurality of other additives. The other additive or plurality of other additives may be added at any stage of the method of producing an electrostatic ink composition. The other additive or plurality of other additives may be selected from a charge adjuvant, a wax, a surfactant, viscosity modifiers, and compatibility additives. The wax may be an incompatible wax.

As used herein, “incompatible wax” may refer to a wax that is incompatible with the resin. Specifically, the wax phase separates from the resin phase upon cooling of the resin fused mixture on a print substrate, for example, a plastic film, during and after the transfer of the ink film to the print substrate, for example, from an intermediate transfer member, which may be a heated blanket.

### Method of Producing the Liquid Electrophotographic Ink Composition

In some examples, the method of producing the liquid electrophotographic ink composition comprises combining the resin, liquid carrier and anti-caking agent. In some examples, the method of producing the liquid electrophotographic ink composition comprises combining the resin, liquid carrier, colorant and anti-caking agent.

In some examples, the method of producing the liquid electrophotographic ink composition comprises combining the resin, liquid carrier and anti-caking agent and concentrating the mixture to form the liquid electrophotographic ink composition. In some examples, the method of producing the liquid electrophotographic ink composition comprises combining the resin, liquid carrier, colorant and anti-caking agent and concentrating the mixture to form the liquid electrophotographic ink composition.

In some examples, the method of producing the liquid electrophotographic ink composition comprises combining the resin and the liquid carrier to form a paste and then combining the paste with the anti-caking agent. In some examples, the method of producing the liquid electrophotographic ink composition comprises combining the resin, the liquid carrier and the colorant to form a paste and then combining the paste with the anti-caking agent.

In some examples, the method of producing the liquid electrophotographic ink composition comprises combining the resin and the liquid carrier to form a paste and then combining the paste with the anti-caking agent and concentrating the mixture to form the liquid electrophotographic ink composition. In some examples, the method of producing the liquid electrophotographic ink composition comprises combining the resin, the liquid carrier and the colorant to form a paste and then combining the paste with the anti-caking agent and concentrating the mixture to form the liquid electrophotographic ink composition.

In some examples, the method of producing the liquid electrophotographic ink composition comprises combining the resin and the liquid carrier to form a paste and then combining the paste with the anti-caking agent and concentrating the mixture and grinding to form the liquid electrophotographic ink composition. In some examples, the method of producing the liquid electrophotographic ink composition comprises combining the resin, the liquid carrier and the colorant to form a paste and then combining the paste with the anti-caking agent and concentrating the mixture and grinding to form the liquid electrophotographic ink composition.

In some examples, the paste is formed by combining and heating the resin and the liquid carrier to an elevated temperature. In some examples, the elevated temperature is above the melting point of the resin. The melting point of the resin may be determined by differential scanning calorimetry, for example, using ASTM D3418. In some examples, the resin and the carrier liquid are combined and heated to a temperature of at least 70° C., for example, at least 80° C., for example, at least 90° C., for example, at least 100° C., for example, at least 110° C., for example, at least 120° C., for example, 130° C., for example, to melt the resin. Melting and/or dissolving a resin in the carrier liquid may result in the carrier fluid appearing clear and homogeneous. In some examples, the resin and carrier liquid are heated before, during or after mixing.

In some examples, the resin and the carrier liquid are mixed at a mixing rate of 500 rpm or less, for example, 400 rpm or less, for example, 300 rpm or less, for example, 200 rpm or less, for example, 100 rpm or less, for example, 75 rpm or less, for example, 50 rpm. In some examples, mixing may continue until melting and/or dissolution of the resin in the carrier liquid is complete.

In some examples, after combining and heating the resin and the carrier liquid, the mixture is cooled to a temperature below the melting point of the resin, for example, to room temperature. In some examples, after combining and heating the resin and the carrier liquid, the colorant is added and the mixture is cooled to a temperature below the melting point of the resin, for example, to room temperature. In some examples, the chargeable particles are removed from the carrier liquid and re-dispersed in a new portion of carrier liquid, which may be the same or a different carrier liquid.

In some examples, after combining the resin, the liquid carrier and optionally the colorant, the mixture is ground to form the paste. In some examples, the charge adjuvant may be added to the mixture before grinding. In some examples, the paste is diluted before grinding. In some examples, the method comprises grinding at a grinding speed of at least 50 rpm. In some examples, the method comprises grinding at a grinding speed of up to about 600 rpm. In some examples, the method comprises grinding for at least 1 h, in some examples, for at least 2 h. In some examples, the method comprises grinding for up to about 12 h. In some examples, the method comprises grinding at a temperature of at least about 30° C., for example, at least about 35° C., for example, at least about 40° C., for example, at least about 50° C. In some examples, the method comprises grinding at a temperature of at least about 50° C. for a first time period, in some examples, for at least 1 h, in some examples, for at least 1.5 h and then reducing the temperature to a temperature of at least 30° C., in some examples, at least 35° C. and continuing grinding for at least 5 h, in some examples, at least 9 h, in some examples, at least 10 h.

In some examples, after grinding, the anti-caking agent is combined with the paste, for example, by mixing. In some examples, the anti-caking agent is combined with the paste and the mixture is concentrated to form the liquid electrophotographic ink composition. In some examples, the anti-caking agent is combined with the paste, the mixture is concentrated and the concentrated mixture is ground to form the liquid electrophotographic ink composition. In some examples, the grinding is for up to 5 min, for example, up to 4 min, up to 3 min, up to 2.5 min, up to 2 min, up to 1.5 min, up to 1 min, up to 50 sec, up to 40 sec. In some examples, the grinding is for 10 sec or more, for example, 15 sec or more, 20 sec or more, 24 sec or more, 30 sec or more, 35 sec or more. In some examples, the grinding is for 10 sec to 5 min, for example, 10 sec to 4 min, 10 sec to 3 min, 15 sec to 2.5 min, 20 sec to 2 min, 25 sec to 1.5 min, 20 sec to 1 min, 35 sec to 50 sec, 35 sec to 40 sec. In some examples, the final grinding step is used only when electrophotographic ink compositions having over 70 wt. % non-volatile solids content are formed.

In some examples, a charge director may be added at any stage of the method.

### Method of Liquid Electrophotographic Printing

In some examples, a method of liquid electrophotographic printing may comprise diluting a liquid electrophotographic ink composition with a liquid carrier to form a print ready composition; and electrophotographically printing the print ready composition onto a substrate. In some examples, the liquid electrophotographic ink composition may comprise any liquid electrophotographic ink composition described above.

In some examples, the method of liquid electrophotographic printing may comprise diluting a liquid electrophotographic ink composition with a liquid carrier to form a print ready composition, the liquid electrophotographic ink composition comprising: a resin comprising a copolymer of an alkylene monomer and a monomer selected from acrylic acid and methacrylic acid; a liquid carrier; and an anti-caking agent present in an amount of up to 1 wt. % of the total solids of the composition; and electrophotographically printing the print ready composition onto a substrate.

In some examples, the print ready composition may comprise up to 10 wt. % non-volatile solids, for example, up to 5 wt. % non-volatile solids, up to 4 wt. % non-volatile solids, up to 3 wt. % non-volatile solids, up to 2 wt. % non-volatile solids.

In some examples, diluting the liquid electrophotographic ink composition with a liquid carrier may comprise adding the liquid carrier to the liquid electrophotographic ink composition and mixing. In some examples, mixing may comprise high speed mixing, for example, mixing at a mixing rate of 200 rpm or more, for example, 250 rpm or more, 300 rpm or more, 350 rpm or more, 400 rpm or more, 450 rpm or more, 500 rpm or more, 550 rpm or more, 600 rpm or more, 650 rpm or more, 700 rpm or more, 750 rpm or more, 800 rpm or more, 850 rpm or more, 900 rpm or more, 950 rpm or more, or 1000 rpm or more. In some examples, mixing may comprise high speed mixing, for example, mixing at a rate of 5000 rpm or less, for example, 4000 rpm or less, 3000 rpm or less, 2500 rpm or less, 2000 rpm or less, 1950 rpm or less, 1900 rpm or less, 1850 rpm or less, 1800 rpm or less, 1750 rpm or less, 1700 rpm or less, 1650 rpm or less, 1600 rpm or less, 1550 rpm or less, 1500 rpm or less, 1450 rpm or less, 1400 rpm or less, 1350 rpm or less, 1300 rpm or less, 1250 rpm or less, 1200 rpm or less, 1150 rpm or less, 1100 rpm or less, 1050 rpm or less, or 1000 rpm or less. In some examples, mixing may comprise high speed mixing, for example, mixing at a mixing rate of about 200 rpm to about 5000 rpm, for example, about 200 rpm to about 4000 rpm, about 200 rpm to about 2000 rpm, about 250 rpm to about 1950 rpm, about 300 rpm to about 1900 rpm, about 350 rpm to about 1850 rpm, about 400 rpm to about 1800 rpm, about 450 rpm to about 1750 rpm, about 500 rpm to about 1700 rpm, about 550 rpm to about 1650 rpm, about 600 rpm to about 1600 rpm, about 650 rpm to about 1550 rpm, about 700 rpm to about 1500 rpm, about 750 rpm to about 1450 rpm, about 800 rpm to about 1400 rpm, about 850 rpm to about 1350 rpm, about 900 rpm to about 1300 rpm, about 950 rpm to about 1250 rpm, about 1000 rpm to about 1200 rpm, about 1000 rpm to about 1150 rpm, about 1000 rpm to about 1100 rpm, about 1000 rpm to about 1050 rpm, or about 1000 rpm to about 1000 rpm. In some examples, mixing may be performed for 20 min or less, for example, 15 min or less, or 10 min or less, 5 min or less, 4.5 min or less, 4 min or less, 3.5 min or less, 3 min or less, 2.5 min or less, 2 min or less, 1.5 min or less, 1 min or less, 55 s or less, 50 s or less, 45 s or less, 40 s or less, 35 s or less, or 0.5 min or less. In some examples, mixing may be performed for 5 s or more, for example, 6 s or more, 7 s or more, 8 s or more, 9 s or more, 10 s or more, 11 s or more, 12 s or more, 13 s or more, 14 s or more, 15 s or more, 16 s or more, 17 s or more, 18 s or more, 19 s or more, 20 s or more, 21 s or more, 22 s or more, 23 s or more, 24 s or more, 25 s or more, 26 s or more, 27 s or more, 28 s or more, 29 s or more, or 30 s or more. In some examples, mixing may be performed for 5 s to 20 min, for example, 6 s to 15 min, 7 s to 10 min, 8 s to 5 min, 9 s to 4.5 min, 10 s to 3 min, 11 s to 3.5 min, 12 s to 3 min, 13 s to 2.5 min, 14 s to 2 min, 15 s to 1.5 min, 16 s to 1 min, 17 s to 55 s, 18 s to 50 s, 19 s to 45 s, 20 s to 5 min, 21 s to 3 min, 22 s to 2.5 min, 23 s to 2 min, 24 s to 1.5 min, 25 s to 1 min, 26 s to 55 s, 27 s to 50 s, 28 s to 5 min, 29 s to 4.5 min, or 30 s to 4 min.

In some examples, the method comprises electrophotographically printing the print ready composition onto a substrate with an electrophotographic printer. In some examples, electrophotographically printing the print ready composition comprises contacting the print ready composition with a latent electrostatic image on a surface to create a developed image and transferring the developed image to a substrate, in some examples, via an intermediate transfer member.

### Substrate

The substrate may be any suitable substrate. The substrate may be any suitable substrate capable of having an image electrophotographically printed thereon. The substrate may include a material selected from an organic or inorganic material. The material may include a natural polymeric material, e.g. cellulose. The material may include a synthetic polymeric material, e.g. a polymer formed from alkylene monomers, including, for example, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (Al), silver (Ag), tin (Sn), copper (Cu), mixtures thereof. In an example, the substrate includes a cellulosic paper. In an example, the cellulosic paper is coated with a polymeric material, e.g. a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The substrate is, in some examples, a cellulosic substrate such as paper. The cellulosic substrate is, in some examples, a coated cellulosic substrate. In some examples, a primer may be coated onto the substrate, before the electrostatic ink composition is printed onto the substrate.

### Printed Substrate

In some examples, a printed substrate may comprise a substrate; and a printed ink composition disposed on the substrate. In some examples, the printed ink composition may be any ink composition described above. In some examples, the printed ink composition may comprise the printed ink composition comprises: a resin comprising a copolymer of an alkylene monomer and a monomer selected from acrylic acid and methacrylic acid; and an anti-caking agent present in an amount of up to 1 wt. % of the total solids of the composition. In some examples, the printed ink composition may be free of or substantially free from carrier liquid. Substantially free from carrier liquid may indicate that the ink printed on the substrate contains less than 5 wt. % carrier liquid, in some examples, less than 2 wt. % carrier liquid, in some examples, less than 1 wt. % carrier liquid, in some examples, less than 0.5 wt. % carrier liquid. In some examples, the ink printed on the substrate is free from carrier liquid.

### Examples

The following illustrates examples of the methods and other aspects described herein. Thus, these Examples should not be considered as limitations of the present disclosure, but are merely in place to teach how to make examples of the present disclosure.

### Materials

### Anti-Caking Agent

AEROSIL R-812: a hydrophobic fumed silica that has been treated with hexamethyldisilazane (available from Evonik).

AEROSIL R-816: a hydrophobic fumed silica that has been treated with hexadecyltrimethoxysilane (available from Evonik).

AEROSIL R-972: a hydrophobic fumed silica that has been treated with dichlorodimethylsilane (available from Evonik).

DEUREX SILICA S-120: a hydrophobic fumed silica (available from Deurex) with an average specific surface of 120 m²/g.

### Properties of the Anti-Caking Agents:

The median particle size of the fumed silica is 5-50 nm.

The fumed silicas are not dissolved in Isopar L.

| Fumed | | Density | Carbon |
|---|---|---|---|
| silica grade | pH | [g/cm³] | content [%] |
| R-812 | 5.5-8.0 | 2.0 | 2.0-3.0 |
| R-816 | 4.0-5.5 | 2.1 | 0.9-1.8 |
| R-972 | 3.6-5.5 | 2.2 | 0.6-1.2 |
| S-120 | 3.5-5.5 | 2.6 | No information |

### Resins

Nucrel® 699: a copolymer of ethylene and methacrylic acid, made with nominally 11 wt. % methacrylic acid (available form DuPont).

AC-5120: a copolymer of ethylene and acrylic acid with an acrylic acid content of 15 wt. % (available from Honeywell).

### Carrier Liquid

Isopar L™: an isoparaffinic oil comprising a mixture of C11-C13 isoalkanes (produced by Exxon Mobil™; CAS number 64742-48-9.

### Pigment

Ti-Pure R900: a rutile TiO₂ pigment (available from Chemours).

### Charge Adjuvant

VCA an aluminium stearate (available from Fisher Scientific™)

### Charge Director

NCD (natural charge director): KT (natural soya lecithin in phospholipids and fatty acids), BBP (basic barium petronate, i.e., a barium sulfonate salt of a 21-26 carbon hydrocarbon alkyl, available from Cemtura™), and GT (dodecyl benzene sulfonic acid isopropyl amine, supplied by Croda™). The composition being 6.6 wt. % KT, 9.8 wt. % BBP and 3.6 wt. % GT and balance (80 wt. %) Isopar L™.

### Ink Composition Production:

### Stage 1: Precipitation Process

Isopar L (2.62 g), Nucrel 699 (0.805 g) and A-C 5120 (0.203 g; 80:20 mixture of Nucrel 699:A-C 5120) were added at RT to a Bachiller mixer (7 L volume). The Bachiller mixer has a central mixing system and a rotor-stator system which can be operated simultaneously.
The resin and mineral oil mixture was heated to 135° C. for 70 min at 200 rpm.
The mixture was cooled to 125° C. over 20 min.
The pigment (2.38 g) was added gradually at rate of 40 g/min, while maintaining the mixture within a temperature range of 100−120° C. At this stage the rotor stator is operating at 2000 rpm, in addition to the regular mixing.
The mixture was then cooled to 83° C. in cooling rate of 12° C./h and a mixing rate of 200 rpm. At this stage the rotor stator is operating at 2000 rpm, in addition to the regular mixing.
The mixture was then cooled to 70° C. at a cooling rate of 1.5° C./h and a mixing rate of 120 rpm.
The mixture was then cooled to 43° C. at a cooling rate of 6° C./h and a mixing rate of 150 rpm.

This forms a composition at 56 wt. % solids with 30 wt. % solids being resin (an 80:20 ratio of Nucrel 699:A-C 5120) and 70 wt. % solids being pigment (Ti-Pure R900).
Isopar L (1.05 g) was then added to the reactor to dilute the mixture to 48 wt. % solids while mixing at 150 rpm. The rotor stator was operated at 500 rpm.
Additional Isopar L (0.47 g) was added to the reactor to dilute the mixture to 45 wt. % solids while mixing at 150 rpm. The rotor stator was operated at 500 rpm.
Additional Isopar L (0.54 g) was added to the reactor to dilute the mixture to 42 wt. % solids while mixing at 150 rpm. The rotor stator was operated at 1000 rpm.

This forms a precipitated ink composition at 42 wt. % solids.

### Stage 2: Grinding Process

The precipitated ink composition (5 kg) at 42% solids was added to a Buhler K8.
VCA (17 g) was added to the mixture.
The mixture was ground at 100% pump flow and 1000 rpm grinding speed. At this stage the temperature is controlled to maintain a temperature of 53° C. or below by using the chiller infrastructure.
The total grinding process time was 4 h.

This forms a ground ink composition at 42 wt. % solids.

### Stage 3: Mixing Process

The ground ink composition (5 kg) at 42% solids was mixed with fumed silica (25 g) in a mixer.
The mixture was mixed at room temperature for 0.5 h.

### Stage 4A: Concentration Process

The mixture was concentrated in lab centrifuge (Rousselet Robatel) under the following conditions:
   Ink capacity: 2000 g;
   Sack pore size: 10 μm;
   Centrifuge speed: 3000 rpm;
   Concentration time: from several min to 1 h.
The ink was concentrated to 63 wt. % solids or 75 wt. % solids.
   For 63 wt. % solids the concentration time was: 10 min.
   For 75 wt. % solids the concentration time was: 1 h.
      Stage 4B: Grinding Process (Only for Concentrated Ink at 75 wt. % Solids; Inks at Below 75 wt. % Solids were Treated According to Stage 5):
The concentrated ink (110 g; 75 wt. % solids) was ground in a coffee grinder for 40 sec until a crumbing ink composition was formed.

### Stage 5: Ink Re-Dispersion in an Inline Dispersion Unit (IDU)

Ink was diluted with Isopar L to 30 wt. % solids or 15 wt. % solids.
1200 g of the diluted composition at 15 wt. % solids was added to the IDU.
The ink was re-dispersed to form a print-ready composition (5 to 8 wt. % solids) at high speed (1000 rpm) for 25 s and then for an additional 25 s. The temperature was monitored during each re-dispersion period.
For each period of re-dispersion, 3 ink samples were taken from several places in the IDU tool and median particle diameter was measured by using a Malvern Mastersizer 2000 Particle Size Analyzer, by following the standard procedure provided in the manual for the machine.

Prior to printing, a charge director (1-6 mg/g solids NCD) was added to the ink composition.

### Results Summary

| | | | | | | Particle size (PS) in the print- | | |
|---|---|---|---|---|---|---|---|---|
| | Anti- | | IDU | | Temp | ready composition | | |
| Ink | caking | wt. % | wt. % | Time | rise | | % < 1.5 | % > 20 |
| no. | agent | solids | NVS | [s] | [° C.] | D (0.5) | μm | μm |
| 1 | DEUREX | 75 | 30 | 25 | 4.4 | 7.8 ± 0.3 | 4.9 ± 0.4 | 15.7 ± 1.1 |
| 2 | SILICA | | | 50 | | 6.2 ± 0.1 | 6.7 ± 0.5 | 6.2 ± 0.9 |
| | S-120 | | | | | | | |
| 3 | AEROSIL | | 15 | 25 | 4.5 | 6.4 ± 0.2 | 6.2 ± 0.1 | 10.1 ± 1.3 |
| 4 | S-812 | | | 50 | | 5.4 | 8.2 ± 0.2 | 1.2 ± 0.3 |
| 5 | | | 30 | 25 | 5 | 6.0 | 8.4 ± 0.2 | 8.7 ± 0.7 |
| 6 | | | | 50 | | 5.6 ± 0.2 | 6.0 ± 0.4 | 8.5 ± 0.3 |
| 7 | — | | 15 | 25 | 7 | 12.8 ± 0.7 | 1.9 ± 0.4 | 37 ± 2 |
| 8 | — | | | 50 | | 7.6 ± 0.5 | 3.6 ± 0.5 | 21.2 ± 4.4 |
| 9 | DEUREX | 70 | 15 | 25 | 5 | 5.1 ± 0.1 | 1.8 ± 0.6 | 6.1 ± 0.1 |
| | SILICA | | | | | | | |
| | S-120 | | | | | | | |
| 10 | — | 70 | 15 | 50 | | Not in spec. ink contains lumps | | |
| 11 | — | 65 | 15 | 50 | | Not in spec. ink contains lumps | | |
| 12 | — | 60 | 15 | 25 | | In spec. | | |
| 13 | DEUREX | 65 | 15 | 25 | >5 | In spec. | | |
| 14 | SILICA | 60 | 15 | 25 | >5 | In spec. | | |
| | S-120 | | | | | | | |

Particle size was measured optically (using a Malvern Mastersizer 2000 Particle Size Analyzer), providing a particle size distribution (volume based particle size). D(0.5) is the median particle size; % < 1.5 μm indicates the percentage of particles having a particle size < 1.5 μm; and % > 20 μm indicates the percentage of particles having a particle size > 20 μm. The specification (spec.) for liquid electrophotographic ink compositions specifies that less the D(0.5) is between 5 μm and 10 μm and that less than 6% of particles have a particle size of above 20 μm. There is no particular requirement for the percentage of particles with a particle size. of below 1.5 μm.

1. Ink compositions which contain DEUREX SILICA S-120 that were concentrated to 75 wt. % solids (inks 1 and 2) were re-dispersed in the IDU tool at 30 wt. % solids for 25 and 50 s. After 50 s of re-dispersion time, the ink particle size was within the specification limits for standard white ink compositions: <6% above 20 μm and D(0.5) between 5 μm and 10 μm.
2. Inks which contain AEROSIL S-812 that were concentrated to 75 wt. % solids (inks 3-6) were re-dispersed in the IDU tool at 15 wt. % and 30 wt. % solids for 25 s and 50 s. For 15 wt. % solid compositions, after 25 s of re-dispersion time, the ink particle size was within the specification limits for standard white ink compositions. For 30 wt. % solids, the ink compositions didn't reach the particle size target even after 50 s re-dispersion time.
3. Inks without silica (stage 3: mixing process was not included in the ink preparation) that were concentrated to 75 wt. % solids (inks 7 and 8) were re-dispersed in the IDU at 30 wt. % solids and gave unacceptable ink compositions that contained lumps. Inks 7 and 8 were re-dispersed at 15 wt. % solids but, even after 50 s of re-dispersion time, the ink particle size was outside the specification limits with a very high volume of particles having a particle size >20 μm.
4. During the re-dispersion process, high shear stress is used and so the ink temperature rises. The acceptable increase in temperature is +5° C. because higher increases in temperature cause agglomeration of particles. Inks 1-6, which include silica, were re-dispersed without raising the temperature outside this limit, while the reference ink compositions (i.e., compositions without silica; inks 7 and 8) were outside the specification limits also for the temperature rise.
5. Inks without silica that were concentrated to 70 wt. % solids and 65 wt. % solids (inks 10 and 11) were re-dispersed at 15 wt. % solids for 50 s. In both cases, the re-dispersion process failed and the inks contained lumps
6. Inks containing DEUREX SILICA S-120 that were concentrated to 70 wt. % solids (ink 9) was re-dispersed without the need for the coffee grinder (stage 4B) and the ink particle size was within the specification for normal white ink compositions.
7. In all cases where the particle size was within the specification, the addition of fumed silica to the ink (inks no. 2, 4, 9, 13 and 14) will not affect the print quality, which will remain the same as the current standard white ink (ink 12).

While the invention has been described with reference to certain examples, those skilled in the art will appreciate that various modifications, changes, omissions, and substitutions can be made without departing from the spirit of the disclosure. It is intended, therefore, that the invention be limited by the scope of the following claims. Unless otherwise stated, the features of any dependent claim can be combined with the features of any of the other dependent claims and any of the independent claims.

1. A liquid electrophotographic ink composition comprising:
a resin comprising a copolymer of an alkylene monomer and a monomer selected from acrylic acid and methacrylic acid;
a liquid carrier; and
an anti-caking agent present in an amount of up to 1 wt. % of the total solids of the composition.

2. The liquid electrophotographic ink composition of claim 1, wherein the anti-caking agent is selected from silica, tricalcium phosphate, powdered cellulose, magnesium stearate, sodium bicarbonate, sodium ferrocyanide, potassium ferrocyanide, calcium ferrocyanide, sodium silicate, calcium silicate, magnesium trisilicate, sodium aluminosilicate, potassium aluminium silicate, calcium aluminosilicate, aluminium silicate, stearic acid, polydimethylsiloxane, and combinations thereof.

3. The liquid electrophotographic ink composition of claim 1, wherein the anti-caking agent is silica.

4. The liquid electrophotographic ink composition of claim 3, wherein the silica is fumed silica.

5. The liquid electrophotographic ink composition of claim 4, wherein the fumed silica is hydrophobic fumed silica.

6. The liquid electrophotographic ink composition of claim 4, wherein the fumed silica has been treated with dimethyldichlorosilane, hexadecylsilane hexamethyldisilazane, diethyldichlorosilane, allylmethyldichlorosilane, trimethylbutoxysilane, trivinyltrimethylcyclotrisiloxane, octamethylcyclotetra-siloxane, hexaethyldisiloxane, pentylmethyldichlorosilane, trimethylchlorosilane, hexamethyldisiloxane, hexenylmethyldichlorosilane, hexenyldimethylchlorosilane, dimethylchlorosilane, or dimethyldichlorosilane.

7. The liquid electrophotographic ink composition of claim 1 further comprising a white pigment.

8. The liquid electrophotographic ink composition of claim 1, wherein the non-volatile solids content of the electrophotographic ink composition is 65 wt. % or more.

9. The liquid electrophotographic ink composition of claim 1, wherein the mean particle size of the anti-caking agent is 50 nm or less.

10. The liquid electrophotographic ink composition of claim 1, wherein the resin comprises a copolymer of an alkylene monomer and an acrylic acid monomer and a copolymer of an alkylene and a methacrylic acid monomer.

11. A method of liquid electrophotographic printing comprising:
diluting a liquid electrophotographic ink composition with a liquid carrier to form a print ready composition, the liquid electrophotographic ink composition comprising:
a resin comprising a copolymer of an alkylene monomer and a monomer selected from acrylic acid and methacrylic acid;
a liquid carrier; and
an anti-caking agent present in an amount of up to 1 wt. % of the total solids of the composition; and
electrophotographically printing the print ready composition onto a substrate.

12. The method of liquid electrophotographic printing of claim 11, wherein prior to dilution, the liquid electrophotographic ink composition has a solids content of 65 wt. % or more.

13. The method of liquid electrophotographic printing of claim 11, wherein diluting the liquid electrophotographic ink composition further comprises mixing the composition at a mixing rate of 200 rpm or more.

14. The method of liquid electrophotographic printing of claim 13, wherein the temperature during mixing increased by 5° C. or less.

15. A printed substrate comprising
a substrate; and
a printed ink composition disposed on the substrate;
wherein the printed ink composition comprises:
a resin comprising a copolymer of an alkylene monomer and a monomer selected from acrylic acid and methacrylic acid; and
an anti-caking agent present in an amount of up to 1 wt. % of the total solids of the composition.
